(19) United States
(12) Patent Application Publication
(10) Pub. No.: US 2009/0228948 A1
(43) Pub. Date: Sep. 10, 2009

(54) VIEWER SELECTION OF SUBTITLE POSITION ON TV SCREEN

(75) Inventors: SANDRA GUARIN, Washington, DC (US); Manish Gupta, San Diego, CA (US); Yuko Nishikawa, La Jolla, CA (US); Edgar Allan Tu, Poway, CA (US); Sabrina Tai-Chen Yeh, Laguna Beach, CA (US)

Correspondence Address: ROGITZ & ASSOCIATES, 750 B STREET, SUITE 3120, SAN DIEGO, CA, 92101, US

(73) Assignees: SONY CORPORATION; SONY ELECTRONICS INC.

(21) Appl. No.: 12/045,152

(22) Filed: Mar. 10, 2008

(51) Int. Cl. H04N 5/278

(52) U.S. Cl. 725/137

(57) ABSTRACT

As part of a user interface for controlling the display of subtitles including closed captioning, a viewer is presented with a menu of alternate screen positions for the subtitles from which the viewer can select a preferred position.

### I. FIELD OF THE INVENTION

The present invention relates generally to allowing viewers to select a position for subtitle display on a TV screen.

### II. BACKGROUND OF THE INVENTION

Subtitles are text transcripts of TV dialogue that can be displayed on a portion of the TV screen. For purposes of the present invention, closed captioning is a species of subtitles, with the difference being that in addition to translating dialogue into on-screen text, closed captions also describe significant audio content and “non-speech information,” such as the identity of speakers and their manner of speaking, along with music or sound effects using words or symbols.

As understood herein, TVs that are enabled for subtitles typically give a viewer the option of displaying subtitles or not, and when displayed, the subtitles appear on screen in a position designated by the broadcaster, which may vary within or between programs. As further understood herein, this may be disruptive for the viewer because depending on the program and the broadcaster-defined subtitle screen position, parts of the video in which the viewer might be most interested can be blocked by the subtitles.

### SUMMARY OF THE INVENTION

A method presents a graphic user interface (GUI) on a TV screen listing plural on screen position options for subtitles received in TV signals. A viewer selection of one of the position options is received and a subtitle address altered in response as necessary to present subtitles at the position option selected by the viewer.

The method may include presenting predetermined on screen position options. At least one position option may be one in which subtitles are overlaid on video and another option may be one in which subtitles are displayed on screen but not overlaid on video. In the latter instance, subtitles can be displayed in a subtitle pane in which no video appears.

In non-limiting embodiments the position options include top of screen overlaid on video, bottom of screen overlaid on video, top of screen not overlaid on video, bottom of screen not overlaid on video. The position options may further include a position as received in broadcast TV signals.

In another aspect, a system includes a TV display, a processor associated with the TV display, and a tuner controllable by the processor to cause programming including subtitle text from a tuned-to channel number to be presented on the display. The processor is configured to change a screen position at which the subtitle text is displayed in response to a viewer command.

In still another aspect, an apparatus is provided for allowing a user to display subtitles on a TV without blocking an area of video on the TV that would otherwise be blocked by subtitles in a broadcaster-defined subtitle position. The apparatus includes a processor receiving a viewer subtitle position command and in response presenting subtitles in an area of the TV corresponding to the position command instead of presenting subtitles in an area of the TV corresponding to the broadcaster-defined subtitle position.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a non-limiting block diagram of a system in accordance with present principles;

FIG. 2 is a flow chart of logic that may be employed by the system of FIG. 1;

FIG. 3 is a screen shot of an example graphic user interface (GUI) that can be used to allow a viewer to select a screen position for subtitles;

FIG. 4 is a screen shot illustrating a viewer selection of “top overlay” for the subtitles; and

FIG. 5 is a screen shot illustrating a viewer selection of “top pane” for the subtitles.

### DETAILED DESCRIPTION OF THE PREFERRED EMBODIMENT

Referring initially to FIG. 1, a system is shown, generally designated 10, which includes a television 12 defining a TV chassis 14 and receiving, through a TV tuner 16 from a cable or satellite or other source or sources 18 audio video TV programming. The tuner 16 may be contained in the set box described below.

The TV 12 typically includes a TV processor 20 accessing a tangible computer readable medium 22. The tangible computer readable medium 22 may be established by, without limitations solid state storage, optical or hard disk storage, etc. The medium 22 may store software executable by the TV processor 20 to, e.g., control a display driver 24 that drives a TV visual display 26 in accordance with one or more settings such as brightness, contrast, and the like that may be stored in, e.g., the medium 22. The display 26 may be a flat panel matrix display, cathode ray tube, or other appropriate video display, and typically is associated with one or more audio speakers 27. The medium 22 may also contain additional code including backend software executable by the TV processor 20 for various non-limiting tasks. One or more of the processors described herein may execute the logic below, which may be stored as computer code on one or more the computer readable media described herein.

In the non-limiting embodiment shown in FIG. 1 the TV 12 may receive programming from external components such as but not limited to a video disk player 28 such as a Blu-Ray or DVD player and a personal video recorder (PVR) 30 that can contain audio-video streams on a hard disk drive.

Additionally, the TV 12 can communicate via a network such as the Internet with a server 32. To this ends the TV 12 may be Internet-enabled, although it is to be understood that the server 32 may be combined with the TV program source 18 when the source 18 is a remote entity accessible over a wide area network, in which case no modem need be provided, with the TV sending signals through a reverse link to the source 18/server 32.

In the non-limiting embodiment shown, the server 32 is separate from the source 18 and the TV 12 communicates with the server 32 through a set-back box (SBB) 34. In some implementations a set-top box (STB) may be used, and the SBB/STB may itself include the tuner 16 or otherwise communicate with the source 18.

In any case, the SBB 34 shown in FIG. 1 may include a SBB processor 36 and SBB computer readable medium 38. The SBB 34 may also include a network interface such as but not limited to a modem 40 to communicate with the server 32 over the Internet. In other implementations the modem 40 may be incorporated into the TV chassis 14.

A wireless remote control 42 can be provided to input commands such as the below-described subtitle position commands into the system 10. The remote control 42 can be a conventional TV remote control or other portable hand-held device.

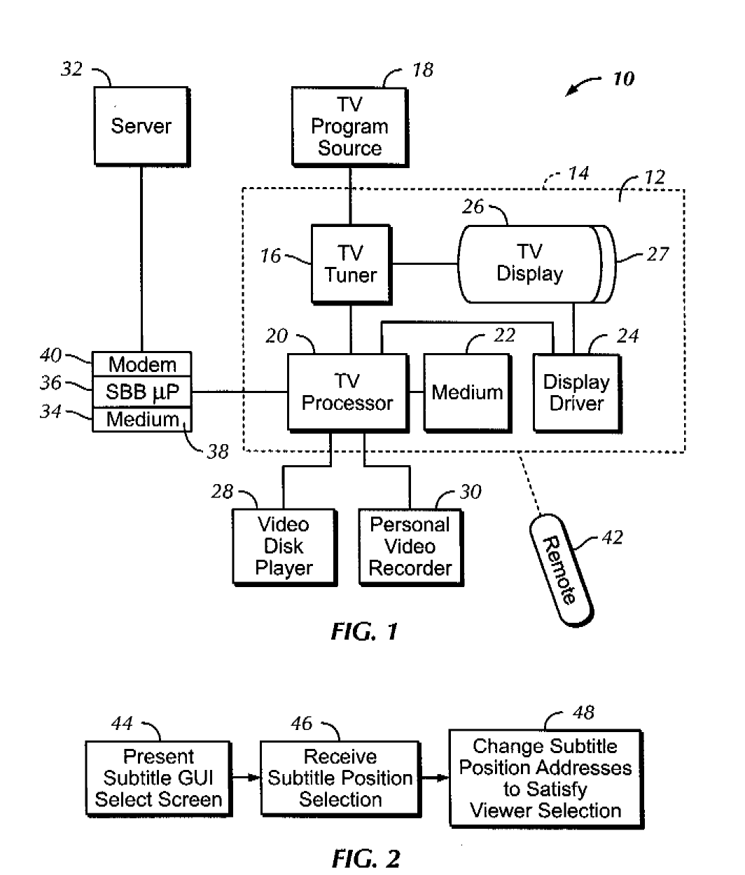

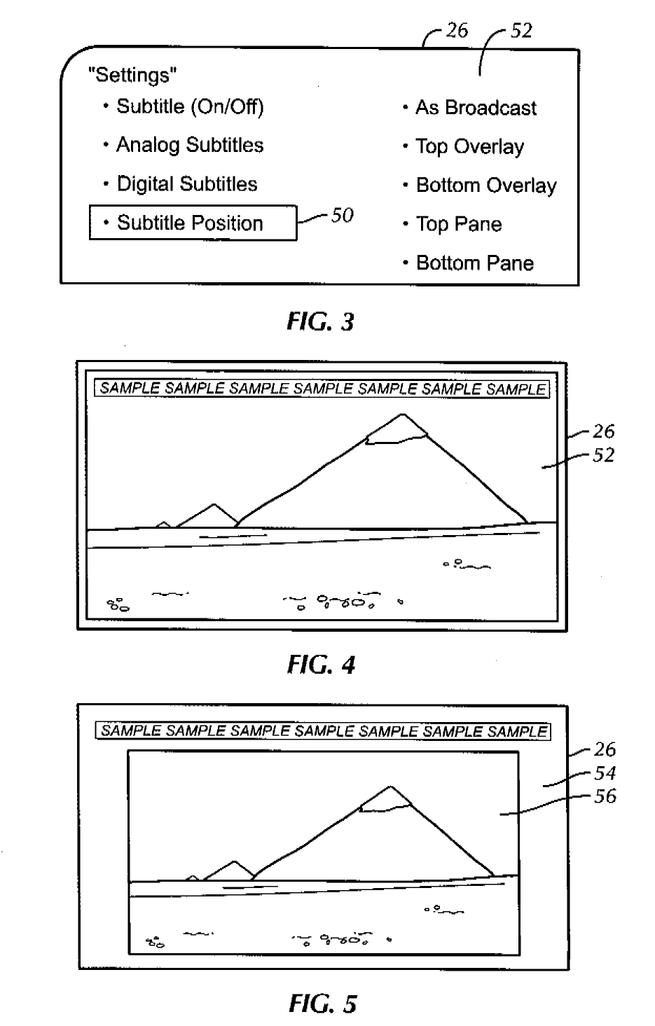

Now referring to FIG. 2, at block 44 a subtitle position graphic user interface (GUI) such as the example GUI shown in FIG. 3 and described below is presented on the display 26. Typically this occurs in response to a viewer using the remote control 42 to navigate through menus, e.g., to select a “settings” entry on a main menu to invoke the subtitle position GUI.

At block 46, a viewer selection of one of the positions presented for selection is received. Then, at block 48 in the event that the viewer has selected a position other than the current subtitle position (which can default to the position received in the broadcast TV signal), the screen address or addresses for subtitle text are changed as necessary to satisfy the viewer's selection.

FIG. 3 shows an example subtitle position GUI that may be presented when a viewer navigates to it through upper level menus such as a “settings” menu. In one implementation the GUI is configured in conjunction with the present assignee's cross-menu bar (XMB) GUI.

As Shown on the left side of the GUI, a viewer may be provided with plural subtitle-related selection options, including turning subtitle display on and off and selecting between analog and digital subtitles. Of focus to the present invention is a subtitle position selection 50 which, if selected by the viewer, can invoke a sub-menu 52 of position options on the right part of the display 26 as shown.

While some implementations may allow fine-granularity viewer definition of subtitle position by, e.g., allowing a viewer to key in numbers representing the address of a desired subtitle area or by allowing a viewer to drag and drop a subtitle box at a desired location on the display, in the preferred embodiment the viewer is permitted to select an option from a predetermined set of subtitle position options as indicated in FIG. 3. For example, the viewer may be permitted to choose from among five options, including to have the subtitles displayed in whatever screen area is defined by subtitle address information received in the broadcast signal. The viewer may be further given the option to have subtitles displayed at the top of the screen or at the bottom regardless of what the broadcasted subtitle address is. These two selections may be further broken down as shown into allowing die viewer to select to have subtitles displayed at the top of the screen overlaid on video 54 as shown in FIG. 4, or not overlaid but rather displayed in a subtitle pane 56 that is separate from a video pane 58 as shown in FIG. 5. In essence the video in the video pane 58 is squeezed from what would otherwise be a full screen video display. Similar overlay/pane options can be provided for bottom of the screen subtitle display. Additional sub-options for a top or bottom selection may be to center the subtitle text on screen or to left- or right-justify the subtitle text.

While the particular VIEWER SELECTION OF SUBTITLE POSITION ON TV SCREEN is herein shown and described in detail, it is to be understood that the subject matter which is encompassed by the present invention is limited only by the claims.

What is claimed is:

1. A method comprising:
presenting a graphic user interface (GUI) on a TV screen listing plural on screen position options for subtitles received in TV signals;
receiving a viewer selection of one of the position options; and
altering at least one subtitle address as necessary to present subtitles at the position option selected by the viewer.

2. The method of claim 1, comprising presenting predetermined on screen position options.

3. The method of claim 1, comprising presenting at least one position option in which subtitles are overlaid on video and at least one position option in which subtitles are displayed on screen but not overlaid on video.

4. The method of claim 3, wherein subtitles are displayed in a subtitle pane in which no video appears if a viewer selects the position option in which subtitles are displayed on screen but not overlaid on video.

5. The method of claim 4, wherein the position options include top of screen overlaid on video, bottom of screen overlaid on video, top of screen not overlaid on video, bottom of screen not overlaid on video.

6. The method of claim 5, wherein the position options further include a position as received in broadcast TV signals.

7. A system, comprising:
a TV display;
a processor associated with the TV display; and
a tuner controllable by the processor to cause programming including subtitle text from a tuned-to channel number to be presented on the display;
the processor configured to change a screen position at which the subtitle text is displayed in response to a viewer command.

8. The system of claim 7, wherein the processor presents a graphic user interface (GUI) on the TV display listing plural on screen positions for subtitles.

9. The system of claim 8, wherein the processor changes at least one subtitle address as necessary to present subtitles at a position selected by a viewer.

10. The system of claim 7, wherein the processor presents predetermined on screen position options to a viewer for selection of one of the options.

11. The system of claim 10, wherein the processor presents at least one position option in which subtitles are overlaid on video and at least one position option in which subtitles are displayed on screen but not overlaid on video.

12. The system of claim 11, wherein subtitles are displayed in a subtitle pane in which no video appears if a viewer selects the position option in which subtitles are displayed on screen but not overlaid on video.

13. The system of claim 12, wherein the position options include top of screen overlaid on video, bottom of screen overlaid on video, top of screen not overlaid on video, bottom of screen not overlaid on video.

14. The system of claim 13, wherein the position options further include a position as received in broadcast TV signals.

15. Apparatus for allowing a user to display subtitles on a TV without blocking an area of video on the TV that would otherwise be blocked by subtitles in a broadcaster-defined subtitle position, comprising:
a processor receiving a viewer subtitle position command and in response presenting subtitles in an area of the TV corresponding to the position command instead of presenting subtitles in an area of the TV corresponding to the broadcaster-defined subtitle position.

16. The apparatus of claim 15, wherein the processor presents on a TV display a graphic user interface (GUI) listing plural on screen position options for subtitles.

17. The apparatus of claim 16, wherein the processor alters at least one subtitle address as necessary to present subtitles at the position option selected by the viewer.

18. The apparatus of claim 17, wherein the processor presents predetermined on screen position options.

19. The apparatus of claim 18, wherein the processor presents at least one position option in which subtitles are overlaid on video and at least one position option in which subtitles are displayed on screen but not overlaid on video.

20. The apparatus of claim 16, wherein the position options include top of screen overlaid on video, bottom of screen overlaid on video, top of screen not overlaid on video, bottom of screen not overlaid on video, position as received in broadcast TV signals.
